(19) United States
(12) Patent Application Publication
(10) Pub. No.: US 2020/0186388 A1
(43) Pub. Date: Jun. 11, 2020

(54) POWER-OVER-ETHERNET-BASED FIELD DEVICE USED IN AUTOMATION TECHNOLOGY

(71) Applicant: Endress+Hauser SE+Co. KG, Maulburg (DE)

(72) Inventors: Tobias Paul, Schopfheim (DE); Ralph Stib, Schönau (DE); Patrick Geib, Bad Säckingen (DE)

(21) Appl. No.: 16/472,517

(22) PCT Filed: Nov. 22, 2017
(86) PCT No.: PCT/EP2017/080064

§ 371 Date: Jun. 21, 2019

(30) Foreign Application Priority Data
Dec. 21, 2016 (DE) 10 2016 125 238.7

(51) Int. Cl. H04L 12/40; H01F 27/42; H04L 12/10

(52) U.S. Cl. CPC H04L 12/40045; H04L 12/10; H01F 27/425

(57) ABSTRACT

The application discloses a power-over-Ethernet-based field device comprising a field device housing, an Ethernet connection so that the field device is suppliable with energy and can exchange data with the network, a voltage converter electronics for converting a voltage applied to the Ethernet connection to an operating voltage, and a field device electronics, which is supplied the operating voltage, and which serves for registering a process variable and communicating the registered process variable in the form of process data via the Ethernet connection, wherein the voltage converter electronics has a first means to heat the interior of the field device housing to a first threshold temperature and which contributes to converting the voltage applied to the Ethernet connection into the operating voltage so that the field device electronics can register the process variable and communicate the registered process variable in the form of process data via the Ethernet connection.

The invention relates to a Power-over-Ethernet-based field device of automation technology.

In automation technology, especially in process automation technology, field devices are often applied, which serve for registering and/or influencing process variables. Serving for registering process variables are sensors, such as, for example, fill-level measuring devices, flow measuring devices, pressure- and temperature measuring devices, pH-redox potential measuring devices, conductivity measuring devices, etc., which register the corresponding process variables, fill level, flow, pressure, temperature, pH value, and conductivity. Serving for influencing process variables are actuators, such as, for example, valves or pumps, via which the flow of a liquid in a pipe, tube or pipeline section, or the fill level in a container, can be changed. Referred to as field devices are, in principle, all devices, which are applied near to the process and which deliver, or process, process relevant information. In connection with the invention, the terminology, field devices, thus, refers especially also to remote I/Os, radio adapters, and, in general, devices, which are arranged at the field level.

A large number of such field devices are produced and sold by the firm, Endress+Hauser.

Power-over-Ethernet (hereinafter also: PoE) refers to supplying network-capable devices also with electrical current via the Ethernet cable. For this, the standard IEEE 802.3-2015 was published in February, 2015. This standard also completely merges the standard IEEE 802.3af of July 2003.

Power-over-Ethernet is being applied increasingly in automation technology, especially in the case of the above described field devices. The application of Power-over-Ethernet offers generally the advantage that separate energy supply lines to devices, especially field devices, can be avoided and, thus, also installation costs can be reduced.

The above mentioned field devices are frequently also operated in very cold regions, in which temperatures of a number of tens of ° C. minus are no rarity. For such service, the electrical circuits located in the field devices must also be correspondingly embodied, since otherwise the electrical circuits no longer function, or no longer function as desired, at such temperatures.

It is, consequently, an object of the invention to provide a Power-over-Ethernet-based field device, which can be safely operated also at low temperatures, especially at temperatures of a number of tens of ° C. minus.

The object of the invention is achieved by a Power-over-Ethernet-based field device of automation technology, comprising:
a field device housing;
an Ethernet connection arranged on the field device housing for connecting the field device to an Ethernet-based network, so that the field device is suppliable via the Ethernet connection with energy and can exchange data with the network;
a voltage converter electronics for converting a voltage applied to the Ethernet connection to an operating voltage;
a field device electronics, which is supplied the operating voltage, and which serves for registering a process variable and communicating the registered process variable in the form of process data via the Ethernet connection;
wherein the voltage converter electronics has at least a first means, which is adapted at least in a first operating state to heat the interior of the field device housing to a first threshold temperature and which, furthermore, contributes in a second operating state to converting the voltage applied to the Ethernet connection into the operating voltage, so that the field device electronics can register the process variable in the second operating state and communicate the registered process variable in the form of process data via the Ethernet connection.

PoE devices are classified according to their power requirement, wherein even the lowest class with a power of up to 3.84 W (watt) provides the field device with sufficient power for the intended operation, in order, also, effectively to heat a field device housing. According to the invention, it is, consequently, proposed that the power provided on the Ethernet connection be used for heating the interior of a field device housing. Such is achieved according to the invention by using, for heating, at least one component, e.g. a means of the voltage converter electronics, which is otherwise provided for energy supply of the field device. In order to be able to draw the power, a detection phase and a classification phase must be traveled through between the so-called Power Source Equipment (short: PSE), thus, an energy supplier, and the Powered Device (short: PD), thus, the consumer, in this case, the field device. The IEEE standard 802.3-2015 Clause 33 defines for this the boundary conditions to be maintained in the two phases. Now, in order that a PoE field device can be heated, the specific electronic components of the field device, which are necessary for heating and/or operating the heating, must be qualified for a predetermined low first threshold temperature, i.e. at least these components must function at the low threshold temperature.

Thus, a PoE field device can convert the power provided by the PSE into heat and heat the interior of the field device housing to at least the first threshold temperature.

An advantageous embodiment of the invention provides that the first means comprises a transformer, which is adapted in such a manner that it serves in the first operating state at least partially, preferably essentially completely, for heating the interior of the field device housing to the first threshold temperature and serves, furthermore, in the second operating state for voltage conversion, so that the field device electronics in the second operating state can register the process variable and communicate the registered process variable in the form of process data via the Ethernet connection.

The embodiment, thus, provides that the transformer is operated differently in the first and second operating states. In the first operating state, the transformer is purposely operated with a poor, low efficiency, so that such issues an increased amount of heat. In the second operating state, the transformer is operated at its optimal working point, with high efficiency, and serves for converting voltage applied to the Ethernet connection into the operating voltage for the field device electronics. The change of the efficiency of the transformer can be achieved, for example, by changing a pulse-pause ratio and/or a frequency applied to the transformer.

An alternative embodiment of the invention provides that the first means comprises at least one resistance element, which is adapted in such a manner that in the first operating state it at least partially, preferably essentially completely, serves for heating the interior of the field device housing to the first threshold temperature and serves, furthermore, in the second operating state for voltage conversion, so that the field device electronics in the second operating state can register the process variable and communicate the registered process variable in the form of process data via the Ethernet connection.

Another advantageous embodiment of the invention provides that the voltage converter electronics is adapted to not supply the field device electronics with energy in the first operating state.

Another advantageous embodiment of the invention provides that the voltage converter electronics is adapted to supply the field device electronics with energy in the second operating state. Especially, this embodiment can provide that the field device electronics and/or the voltage converter electronics are/is adapted in such a manner that essentially a constant power is available to the field device electronics in the second operating state and/or that the first means for heating is controlled in such a manner that a total power, which is consumed via the Ethernet connection, is, and remains, essentially constant and the power required for operation is available to the field device electronics, so that the field device electronics can register the process variable and communicate the registered process variable in the form of process data via the Ethernet connection.

Another advantageous embodiment of the invention provides that the first threshold temperature is selected from a range from −30° C. to −70° C., preferably from a range from −35° C. to −45° C., especially preferably from a range from −55° C. to −65° C.

In turn, another advantageous embodiment of the invention provides that the first means is adapted, furthermore, to heat the interior of the field device housing up to a second threshold temperature. Especially, the embodiment can provide that the field device electronics and/or the voltage converter electronics are/is, furthermore, adapted in such a manner that in a temperature range between the first and second threshold temperatures the total power consumed via the Ethernet connection serves partially for operating the field device electronics, so that the field device electronics can register the process variable and communicate the registered process variable in the form of process data via the Ethernet connection and the remaining power serves for heating the interior of the field device housing by means of the first means and/or that the second threshold temperature is selected from a range from 5° C. to −25° C., preferably from a range from 5° C. to −5° C., especially preferably from a range from −15° C. to −25° C.

The object is achieved, furthermore, by use of a Power-over-Ethernet-based field device of one of the above described embodiments in an environment with, externally surrounding the field device housing, a temperature, which lies below the first threshold temperature and/or the second threshold temperature.

The invention will now be explained in greater detail based on the appended drawing, the figures of which show as follows:

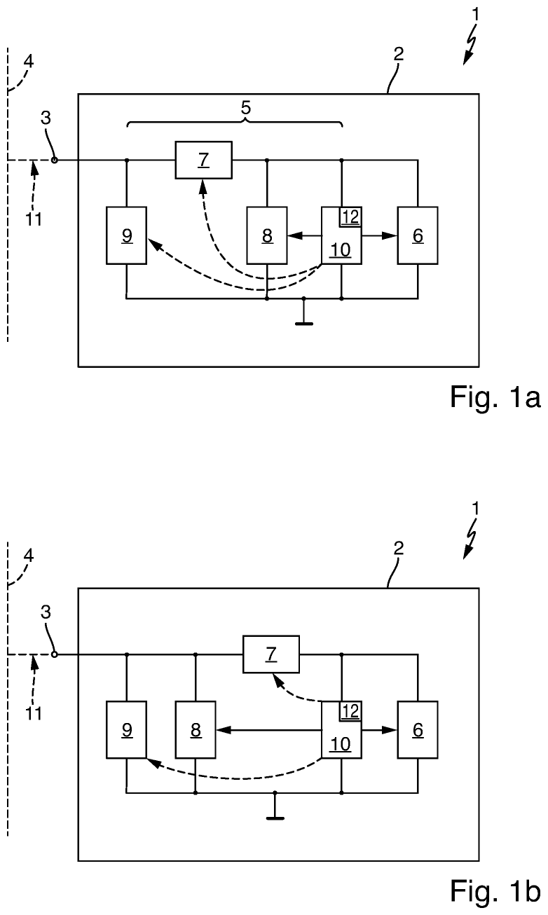

FIG. 1a a schematic block diagram of a first example of an embodiment of a PoE field device of the invention,

FIG. 1b a schematic block diagram of a second example of an embodiment of the PoE field device of the invention.

FIG. 1a shows a block diagram of a first example of a PoE field device 1 of the invention. The PoE field device 1 includes a field device housing 2, in which a voltage converter electronics 5 and a field device electronics 6 are arranged. Field device housing 2 includes an external Ethernet connection 3, via which the PoE field device 1 is connectable with a PoE-capable Ethernet cable 11 to an Ethernet-network 4. Via the PoE-capable Ethernet cable 11, the field device 1 is, in the connected state, supplied with energy. For this, there is provided (not shown in FIG. 1a) an energy supply unit (PSE), which is likewise connected with the Ethernet network 4.

Voltage converter electronics 5 is, in principle, adapted in a first operating state to heat the interior of the field device housing 2 and in a second operating state to convert the voltage applied to the Ethernet connection 3 into an operating voltage. For this, the voltage converter electronics 5 shown in FIG. 1a includes a transformer 7, which serves both for voltage conversion as well as also for heating the interior of the field device housing 2. In order to control the transformer 7 corresponding to the desired function, thus, heating or converting, the voltage converter electronics 5 includes, furthermore, a control circuit 10. Control circuit 10 is adapted to control the transformer 7 in the first operating state in such a manner that it has a poor efficiency, in order to be able to heat the interior above the first threshold temperature. Furthermore, the voltage converter electronics 5 is adapted to control the transformer 7 in the second operating state in such a manner that such is operated at an essentially optimal working point and, thus, also has a best possible efficiency, in order to convert the voltage applied to the Ethernet connection 3 into the operating voltage. For this, a driver unit 9 can be provided, which drives the transformer 7. The driver unit 9 can be so influenced by the control circuit 10 that the efficiency of the transformer 7 is high or low, corresponding to the particular operating mode.

In the case, in which a resistance is used for heating instead of the transformer 7, the control circuit 10 then controls the resistance 8, which serves for the heating. Used as resistance for heating can be either a resistance component of the voltage converter electronics 5 or of the field device electronics 6. By way of example, the resistance element for heating in FIG. 1a is arranged between the transformer 7 and the control circuit 10, i.e. after the transformer. It can, however, also be arranged between the Ethernet connection 3 and the transformer 7, i.e. in front of the transformer, as shown in FIG. 1b.

Control circuit 10 is also adapted to register an internal temperature reigning in the field device housing 2, and, based on the internal temperature, to switch between the first and second operating states. For this, the control circuit 10 or the field device electronics 6 can include a temperature sensor element 12, for example, a platinum temperature sensor. Temperature sensor element 12 can be embodied as a separate element in the voltage converter electronics 5, or field device electronics 6, or be formed by an element, which must unavoidably be present in the voltage converter electronics 5, or the field device electronics 6, as the case may be.

The first operating state is characterized by the feature that the internal temperature lies below the first threshold temperature. In this operating state, the control circuit controls the transformer in such a manner that such essentially serves completely for heating. This means that in the first operating state, the field device electronics is essentially not supplied with energy by the voltage converter electronics. Because of the heating, it is assured that components, which are qualified at the first threshold temperature, are not operated below this threshold temperature.

The second operating state is characterized by the feature that, from the beginning, the internal temperature lies above the first threshold temperature. In this operating state, the control circuit 10 controls the transformer 7 in such a manner that such serves for converting the voltage into the operating voltage. Furthermore, the control circuit 10 in the second operating state can also drive the transformer 7 partially for heating. Thus, for example, it can be provided that the total power provided via the Ethernet connection 3, for example, 3.84 W, when the PoE field device 1 is classified in the lowest class, is divided by the control circuit 10 in such a manner that the field device electronics 6 receives an essentially constant power required for functioning and a remaining power fraction is used for heating the field device interiors by the transformer 7. This means that the control 10 of the transformer 7 occurs dynamically. In this way, the field device electronics 6 can work as desired in the second operating state and register a process variable and communicate the process variable in the form of process data via the Ethernet connection 3.

In the case, in which the PoE field device 1 is a type 2 PD device having an integrated Data Link Layer of the IEEE802.3-2015 standard, the control circuit 10 can also be embodied in such a manner that such performs a dynamic change of the classification in the ongoing operation of the PoE field device 1, so that the power provided to the Ethernet connection 3 is increased. This can be performed, for example, when the internal temperature lies significantly below the first threshold temperature and, thus, the heating of the field device interiors would last inacceptably long. Control circuit 10 can then be adapted in such a manner that it starts the PoE field device with a higher power class, e.g. about 13 W instead of 3.84 W, and after reaching the first threshold temperature, starts the PoE field device in a lower power class.

Furthermore, the control circuit 10 can be adapted in such a manner that upon reaching a second threshold temperature the transformer 7 serves exclusively for converting the voltage applied on the Ethernet connection 3 into the operating voltage.

The control unit 10 can, furthermore, be adapted not to supply the field device electronics 6 with electrical current in the first operating state, while in the second operating state the field device electronics 6 is supplied with the needed power. For example, this can be implemented via a switch in the form of a transistor, which is operated by the control unit 10 in the first operating state in such a manner that the field device electronics 6 is electrically isolated from the voltage converter electronics 5 and in the second operating state the field device electronics 6 is electrically connected with the voltage converter electronics 5, so that the field device electronics 6 receives the appropriate power.

Alternatively, the turning of the field device electronics on- and off could also occur by a signal from the control unit 10 to the driver unit 9, which, in this case, then is adapted in the first operating state to isolate the field device electronics 6 from the voltage converter electronics 5, thus, to turn off the field device, and in the second operating state to connect the field device electronics 6 electrically with the voltage converter electronics 5.

The PoE field device 1 can, thus, be operated in an environment, which has an ambient temperature, i.e. a temperature externally surrounding the field device housing 2, which is lower than the first threshold temperature. For example, the PoE field device 1 can be operated at an ambient temperature of less than −40° C., wherein the field device 1 is embodied in such a manner that the first threshold temperature is about −40° C. and the second threshold temperature is about −20° C. The operating temperatures, thus, the first and, in given cases, the second threshold temperatures, are, in such case, adaptable to the particular location of use. In principle, the threshold temperatures can be selected as desired, when the PoE field device 1 is correspondingly adapted. Proved to be especially suitable for the first threshold temperature has been a temperature value in the range from −30° C. to −70° C., especially the temperature value of −60° C. Proved especially suitable for the second threshold temperature has been a temperature value in the range from 5° C. to −25° C., especially the temperature value of −20° C.

### LIST OF REFERENCE CHARACTERS

1 PoE field device of automation technology
2 field device housing
3 Ethernet connection
4 network
5 voltage converter electronics
6 field device electronics
7 transformer
8 resistance element for heating
9 driver unit
10 control circuit
11 Ethernet cable
12 temperature sensor element

1-12. (canceled)

13. A power-over-Ethernet-based field device of automation technology comprising:
a field device housing;
an Ethernet connection arranged on the field device housing for connecting the field device to an Ethernet-based network, so that the field device is suppliable via the Ethernet connection with energy and can exchange data with the network;
a voltage converter electronics for converting a voltage applied to the Ethernet connection to an operating voltage; and
a field device electronics, which is supplied the operating voltage, and which serves for registering a process variable and communicating the registered process variable in the form of process data via the Ethernet connection,
wherein the voltage converter electronics has at least a first means, which is adapted in a first operating state to heat the interior of the field device housing to a first threshold temperature and which, furthermore, contributes in a second operating state to converting the voltage applied to the Ethernet connection into the operating voltage so that the field device electronics can register the process variable in the second operating state and communicate the registered process variable in the form of process data via the Ethernet connection.

14. The power-over-Ethernet-based field device as claimed in claim 13,
wherein the first means includes a transformer, which is adapted in such a manner that it serves in the first operating state at least partially for heating the interior of the field device housing to the first threshold temperature and serves, furthermore, in the second operating state for voltage conversion so that the field device electronics in the second operating state can register the process variable and communicate the registered process variable in the form of process data via the Ethernet connection.

15. The power-over-Ethernet-based field device as claimed in claim 13,
wherein the first means includes at least one resistance element, which is adapted such that in the first operating state it at least partially serves for heating the interior of the field device housing to the first threshold temperature and, in the second operating state for voltage conversion so that the field device electronics in the second operating state can register the process variable and communicate the registered process variable in the form of process data via the Ethernet connection.

16. The power-over-Ethernet-based field device as claimed in claim 13,
wherein the voltage converter electronics is adapted to not supply the field device electronics with energy in the first operating state.

17. The power-over-Ethernet-based field device as claimed in claim 13,
wherein the voltage converter electronics is adapted to supply the field device electronics with energy in the second operating state.

18. The power-over-Ethernet-based field device as claimed in claim 17, wherein the field device electronics and/or the voltage converter electronics are/is adapted such that essentially a constant power is available to the field device electronics in the second operating state.

19. The power-over-Ethernet-based field device as claimed in claim 18,
wherein the first means for heating is controlled such that a total power, which is consumed via the Ethernet connection, is, and remains, essentially constant and the power required for operation is available to the field device electronics, so that the field device electronics can register the process variable and communicate the registered process variable in the form of process data via the Ethernet connection.

20. The power-over-Ethernet-based field device as claimed in claim 13,
wherein the first threshold temperature is selected from a range from −30° C. to −70° C.

21. The power-over-Ethernet-based field device as claimed in claim 13,
wherein the first means is further adapted to heat the interior of the field device housing up to a second threshold temperature.

22. The power-over-Ethernet-based field device as claimed in claim 21,
wherein the field device electronics and/or the voltage converter electronics are/is further adapted such that in a temperature range between the first and second threshold temperatures the total power consumed via the Ethernet connection serves partially for operating the field device electronics, so that the field device electronics can register the process variable and communicate the registered process variable in the form of process data via the Ethernet connection and the remaining power serves for heating the interior of the field device housing by means of the first means.

23. The power-over-Ethernet-based field device as claimed in claim 22,
wherein the second threshold temperature is selected from a range from 5° C. to −25° C.

24. A use of a Power-over-Ethernet-based field device, the field device including:
a field device housing;
an Ethernet connection arranged on the field device housing for connecting the field device to an Ethernet-based network, so that the field device is suppliable via the Ethernet connection with energy and can exchange data with the network;
a voltage converter electronics for converting a voltage applied to the Ethernet connection to an operating voltage; and
a field device electronics, which is supplied the operating voltage, and which serves for registering a process variable and communicating the registered process variable in the form of process data via the Ethernet connection,
wherein the voltage converter electronics has at least a first means, which is adapted in a first operating state to heat the interior of the field device housing to a first threshold temperature and which, furthermore, contributes in a second operating state to converting the voltage applied to the Ethernet connection into the operating voltage so that the field device electronics can register the process variable in the second operating state and communicate the registered process variable in the form of process data via the Ethernet connection,
wherein the use is in an environment with, externally surrounding the field device housing, a temperature, which lies below the first threshold temperature and/or the second threshold temperature,
wherein the first threshold temperature is in the range from −30° C. to −70° C., and
wherein the second threshold temperature is in the range from 5° C. to −25° C.
